(19) United States
(12) Patent Application Publication
(10) Pub. No.: US 2015/0061965 A1
(43) Pub. Date: Mar. 5, 2015

(54) ANTENNA DEVICE

(71) Applicant: Hitachi Metals, Ltd., Tokyo (JP)

(72) Inventors: Naoki ISO, Hitachi (JP); Tomoyuki OGAWA, Hitachi (JP); Nobuaki KITANO, Hitachi (JP); Yoshiaki ISHIGAMI, Hitachi (JP)

(73) Assignee: Hitachi Metals, Ltd.

(21) Appl. No.: 14/332,726

(22) Filed: Jul. 16, 2014

(30) Foreign Application Priority Data
Aug. 30, 2013 (JP) 2013-179483

(51) Int. Cl. H01Q 1/50

(52) U.S. Cl. CPC H01Q 1/50
USPC 343/905

(57) ABSTRACT

An antenna device includes a first triplate line and one or more second triplate lines that are connected to the first triplate line so as to cross the first triplate line. Two ground plates of each second triplate line include respective flange portions that are in contact with and fixed to a surface of one of two ground plates of the first triplate line. At least one of a surface of each flange portion that contacts the one of the ground plates of the first triplate line and the surface of the one of the ground plates of the first triplate line that contacts each flange portion is provided with an irregular portion for reducing a contact area between each flange portion and the one of the ground plates.

The present application is based on Japanese patent application No. 2013-179483 filed on Aug. 30, 2013, the entire contents of which are incorporated herein by reference.

### BACKGROUND OF THE INVENTION

1. Field of the Invention The present invention relates to an antenna device.

2. Description of the Related Art

An antenna device including a triplate line, in which a central conductor plate is interposed between two ground plates, as a feed line has been developed as an example of an antenna device having a simple structure with which loss in the feed line can be reduced (see, for example, Japanese Unexamined Patent Application Publication No. 63-88902).

With the antenna device including the triplate line as the feed line, in the case where the antenna device is a frequency-sharing antenna capable of transmitting and receiving signals in a plurality of frequency bands, the feed line is required for each frequency band and each polarization. When all of the feed lines are assembled in a single triplate line, the triplate line has an extremely large area, and the size of the antenna device is increased.

Accordingly, the assignee of the present invention has proposed an antenna device including multiple triplate lines that are connected together so as to cross each other.

However, with the proposed antenna device, there is a risk that a contact failure will occur in a section where the ground plates of the triplate lines are connected to each other and intermodulation (IM) distortion will be increased.

### SUMMARY OF THE INVENTION

Accordingly, an object of the present invention is to solve the above-described problem and provide an antenna device with which the intermodulation distortion can be reduced.

The present invention has been made to achieve the above-described object. An antenna device according to an aspect of the present invention includes triplate lines used as feed lines, each triplate line including two ground plates and a central conductor interposed between the ground plates with an air layer provided between the central conductor and each ground plate. The triplate lines include a first triplate line and a second triplate line connected to the first triplate line across the first triplate line. The two ground plates of the second triplate line include respective flange portions configured to contact with a surface of one of the ground plates of the first triplate line. The triplate lines include an irregular portion formed on at least one of a surface of each flange portion contacting the one of the ground plates of the first triplate line and the surface of the one of the ground plates of the first triplate line contacting each flange portion. The irregular portion is configured to reduce a contact area between each flange portion and the one of the ground plates.

The irregular portion may be formed only on the surface of the one of the ground plates of the first triplate line that contacts each flange portion.

Each flange portion may be fastened to the ground plates of the first triplate line with a bolt.

The irregular portion may include a protrusion formed by embossing.

The irregular portion may include a recess.

According to the present invention, an antenna device with which intermodulation distortion can be reduced can be provided.

### BRIEF DESCRIPTION OF THE DRAWINGS

FIG. 1A is a schematic sectional view illustrating the manner in which triplate lines are connected in an antenna device according to an embodiment;

FIG. 1B is a sectional view of a connecting portion of a first triplate line and a second triplate line;

FIG. 2A is a perspective view illustrating an external appearance of the antenna device according to the embodiment;

FIG. 2B is a perspective view of the antenna device in the state in which a radome, some of the triplate lines, and antenna elements are removed;

FIG. 3 is a perspective view illustrating the structure of a second triplate line, which is included in the antenna device illustrated in FIG. 1, in the state in which one ground plate is removed;

FIG. 4 is a perspective view illustrating the structure of an antenna element included in the antenna device illustrated in FIG. 1;

FIG. 5 is a perspective view of a ground plate of the first triplate line included in the antenna device illustrated in FIG. 1; and

FIG. 6 is a sectional view of a connecting portion of a first triplate line and a second triplate line according to a modification of the present invention.

### DESCRIPTION OF THE PREFERRED EMBODIMENTS

An embodiment of the present invention will be described with reference to the accompanying drawings.

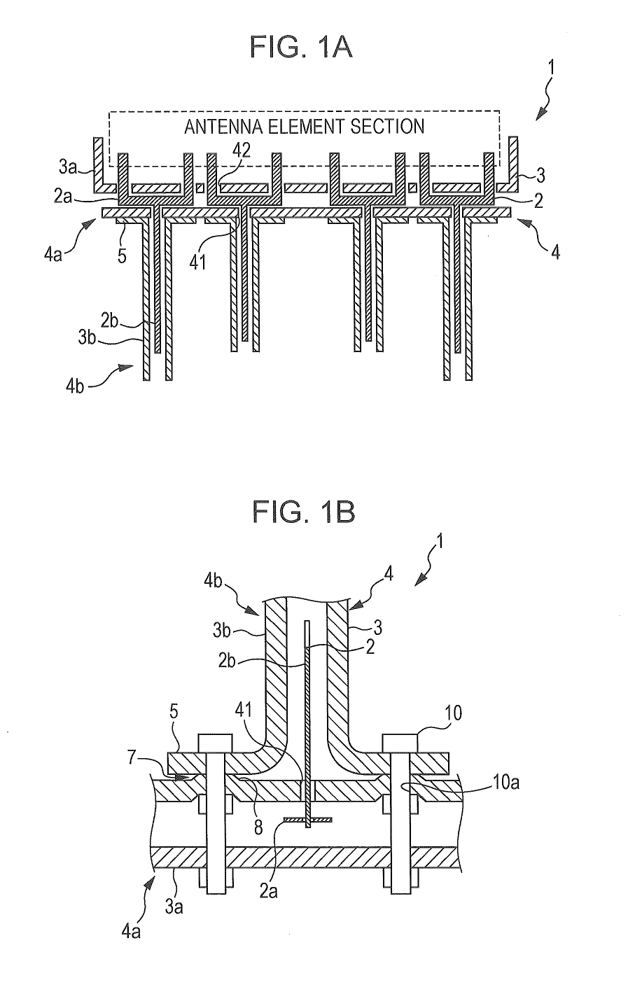

FIG. 1A is a schematic sectional view illustrating the manner in which triplate lines are connected in an antenna device according to the present embodiment. FIG. 1B is a sectional view of a connecting portion of a first triplate line and a second triplate line.

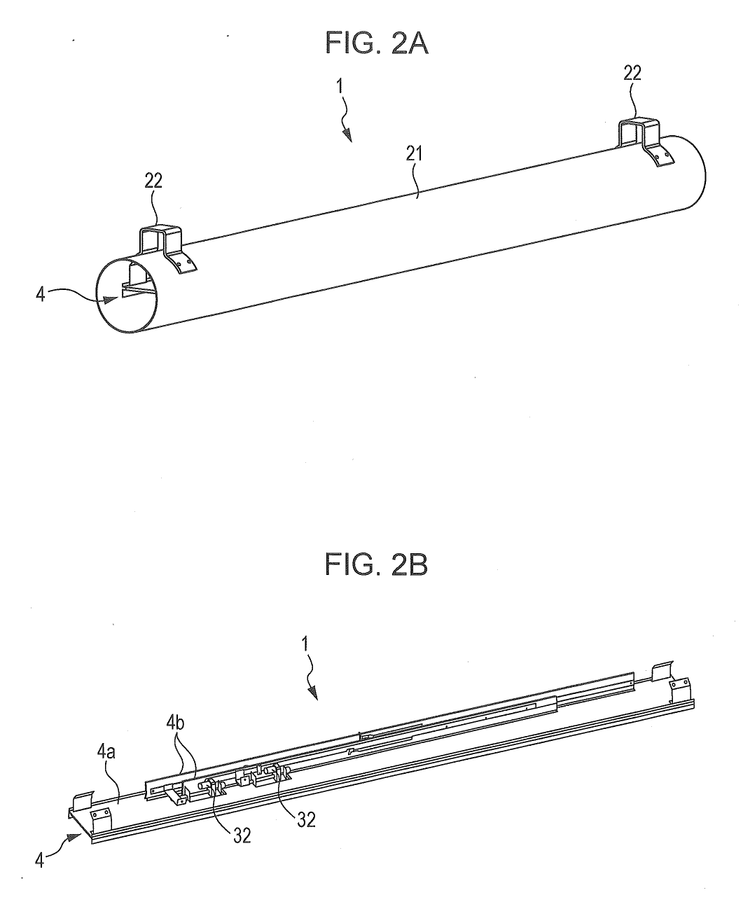

FIG. 2A is a perspective view illustrating an external appearance of the antenna device according to the present embodiment. FIG. 2B is a perspective view of the antenna device in the state in which a radome, some of the triplate lines, and antenna elements are removed.

As illustrated in FIGS. 1A, 1B, 2A, and 2B, an antenna device 1 includes triplate lines 4 as feed lines, each triplate line 4 including two ground plates 3 and a central conductor 2 interposed between the ground plates 3 with an air layer provided between the central conductor 2 and each ground plate 3. The antenna device 1 is used as, for example, a base station antenna for mobile communication.

The antenna device 1 includes a cylindrical radome 21. The triplate lines 4 are contained in the radome 21. Both ends of the radome 21 are covered with antenna caps (not shown). Attachment pieces 22 used to fix the radome 21 to an antenna tower or the like are provided on the radome 21. The antenna device 1 is attached to the antenna tower or the like by using the attachment pieces 22 such that the axial direction (longitudinal direction) of the radome 21 is vertical.

In the present embodiment, it is assumed that the antenna device 1 is a frequency-sharing antenna capable of transmitting and receiving signals in two frequency bands. When the antenna device 1 is used as a frequency-sharing antenna for two frequency bands, and when vertical and horizontal polarizations are used for each frequency band, four feed lines are required. If all of the four feed lines are assembled in a single triplate line 4, the triplate line 4 has an extremely large area, and the size of the antenna device is increased. Accordingly, in the present embodiment, multiple triplate lines 4 are provided, and are connected together so as to cross each other.

More specifically, the triplate lines 4 include a first triplate line (horizontal triplate line) 4a and one or more second triplate lines (vertical triplate lines) 4b that are connected to the first triplate line 4a so as to cross the first triplate line 4a. In this embodiment, one second triplate line 4b is provided for each of the four feed lines, and four second triplate lines 4b are provided in total. The four second triplate lines 4b are connected to the first triplate line 4a so as to be orthogonal to the first triplate line 4a.

The antenna device 1 is configured such that feed signals supplied from the outside are transmitted from the second triplate lines 4b to respective antenna elements through the first triplate line 4a. Here, the four second triplate lines 4b are arranged parallel to each other with intervals therebetween. Two second triplate lines 4b for a low frequency band (for example, 700 to 800 MHz) and the respective polarizations are disposed on the outer side, and two second triplate lines 4b for a high frequency band (for example, 1.5 to 2 GHz) and the respective polarizations are disposed on the inner side. The number of frequency bands is not limited to two, and the number and arrangement of the second triplate lines 4b are not limited to those in the figures.

The first triplate line 4a is configured such that a central conductor plate 2a, which is formed of a metal plate that serves as the central conductor 2, is interposed between two ground plates 3a with an air layer provided between the central conductor 2a and each ground plate 3a. The two ground plates 3a are arranged so as to be parallel to each other and face each other, and the central conductor plate 2a is arranged at a position equally spaced from the two ground plates 3a, that is, at the midpoint between the ground plates 3a.

Each second triplate line 4b is configured such that a central conductor plate 2b, which is formed of a metal plate that serves as the central conductor 2, is interposed between two ground plates 3b with an air layer provided between the central conductor 2b and each ground plate 3b. The two ground plates 3b are arranged so as to be parallel to each other and face each other, and the central conductor plate 2b is arranged at a position equally spaced from the two ground plates 3b, that is, at the midpoint between the ground plates 3b. The ground plates 3a and 3b are made of aluminum, which is light and inexpensive, and has high weather resistance.

As illustrated in FIGS. 1A to 3, dielectric-insertion-type phase shifters 31 are provided on the central conductor plates 2b of the second triplate lines 4b. The feed signals input from the outside are output to the first triplate line 4a after being distributed and subjected to phase adjustment. The dielectric-insertion-type phase shifters 31 are connected to respective linear motor units 32 for moving dielectric plates included therein along the central conductor plates 2b.

The two ground plates 3b of each second triplate line 4b have flange portions 5, which are in contact with and fixed to a surface of one of the ground plates 3a of the first triplate line 4a, and are substantially L-shaped in cross section. The flange portions 5 are fastened to the two ground plates 3a of the first triplate line 4a with bolts 10, so that the ground plates 3a and 3b are electrically connected and fixed to each other. Thus, the triplate lines 4a and 4b are fixed to each other.

An end of the central conductor plate 2b of each second triplate line 4b protrudes outward from the ground plates 3b, extends through a through hole 41 formed in one of the ground plates 3a of the first triplate line 4a, and is soldered on the central conductor plate 2a of the first triplate line 4a so as to be electrically connected to the central conductor plate 2a.

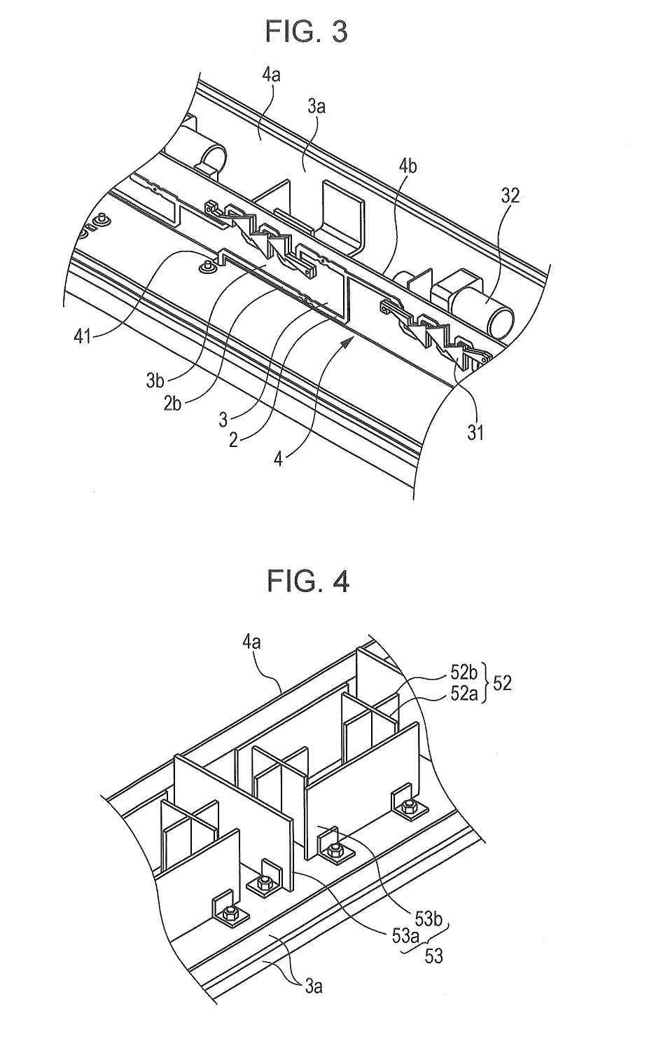

As illustrated in FIG. 4, antenna elements are disposed on the first triplate line 4a at a side opposite to a side at which the second triplate lines 4b are disposed. Thus, in the antenna device 1, the second triplate lines 4b are provided on one of the ground plates 3a of the first triplate line 4a, and the antenna elements are provided on the other of the ground plates 3a of the first triplate line 4a.

The antenna elements are constructed by forming a wiring pattern on a plate-shaped substrate made of an insulator, such as a resin, and are arranged so as to stand on one of the ground plates 3a of the first triplate line 4a.

The antenna elements include two pairs of antenna elements 52 and 53 which correspond to the respective frequency bands. A first pair of antenna elements 52 is for the high frequency band, and includes a first horizontal polarization antenna element 52a and a first vertical polarization antenna element 52b. A second pair of antenna elements 53 is for the low frequency band, and includes a second horizontal polarization antenna element 53a and a second vertical polarization antenna element 53b. The structure and arrangement of the antenna elements are not limited to those illustrated in the figures. The antenna elements are electrically connected to the central conductor plate 2a of the first triplate line 4a via through holes 42 formed in one of the ground plates 3a of the first triplate line 4a (see FIG. 1A).

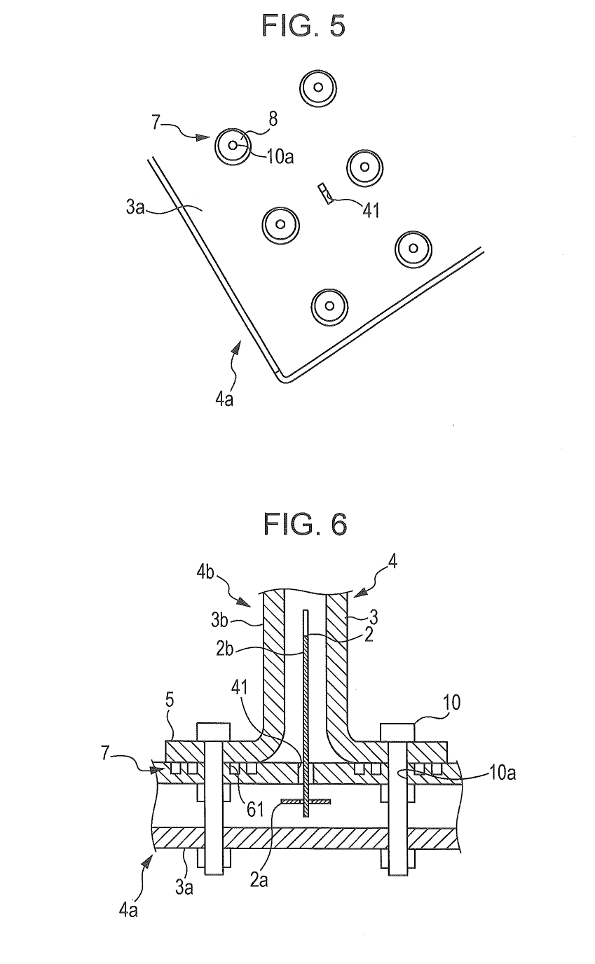

As illustrated in FIGS. 1B and 5, in the antenna device 1 of the present embodiment, at least one of a surface of each flange portion 5 that contacts one of the ground plates 3a and a surface of the ground plate 3a that contacts the flange portions 5 has an irregular portion 7 for reducing a contact area between each flange portion 5 and the ground plate 3a.

In the present embodiment, the irregular portion 7 is formed only on the surface of the ground plate 3a. However, the irregular portion 7 may instead be formed only on the contact surface of each flange portion 5, or on both of the surface of the ground plate 3a and the contact surface of each flange portion 5.

In the case where the irregular portion 7 is formed on each flange portion 5, it is necessary to perform the process of forming the irregular portion 7 on a plurality of members (in this example, on each of the eight ground plates 3b). However, in the case where the irregular portion 7 is formed only on the surface of the ground plate 3a, it is only necessary to perform the process on the ground plate 3a. Therefore, from the viewpoint of ease of manufacture, the irregular portion 7 is preferably formed only on the ground plate 3a as in the present embodiment.

In the antenna device 1, the irregular portion 7 includes protrusions 8 formed by an embossing process in which a rear surface is pressed so that a front surface protrudes outward. In this example, the protrusions 8 have a circular shape in plain view, and are centered on holes 10a for receiving the bolts 10. However, the shape of the protrusions 8 is not limited to this. Also, in this example, the height of the protrusions 8 (distance between the surface of the ground plate 3a and the top portion of each protrusion 8) is 1 mm. However, the height of the protrusions 8 can be changed as appropriate.

Since the protrusions 8 are formed as the irregular portion 7, only the top portions of the protrusions 8 contact the flange portions 5. Therefore, when the flange portions 5 of the ground plates 3b are fastened to the ground plates 3a with the bolts 10, the contact area can be reduced and the contact surface pressure between the ground plates 3a and 3b can be increased. As a result, the ground plates 3a and 3b can be stably and strongly fixed to each other, and the reliability of electrical connection therebetween can be increased.

The size and number of protrusions 8 are not particularly limited, and can be set as appropriate so that reliable electrical connection can be provided between the ground plates 3a and 3b. In the present embodiment, the protrusions 8 are located directly below the positions at which the bolts 10 are disposed. However, the protrusions 8 may instead be formed at positions other than the positions at which the bolts 10 are disposed.

In the present embodiment, the protrusions 8 are formed as the irregular portion 7. However, as illustrated in FIG. 6, recesses 61 may instead be formed as the irregular portion 7. The recesses 61 may be formed such that the contact area between the flange portion 5 of each ground plate 3b and one of the ground plates 3a can be reduced and sufficient contact surface pressure can be obtained. In FIG. 6, the recesses 61 are formed in the ground plate 3a. However, the recesses 61 may instead be formed in the flange portion 5 of each ground plate 3b. The recesses 61 are not limited to those having a linear shape, and may have any shape.

As described above, in the antenna device 1 according to the present embodiment, at least one of the surface of the flange portion 5 of each ground plate 3b that contacts one of the ground plates 3a and the surface of the ground plate 3a that contacts the flange portions 5 has the irregular portion 7 for reducing the contact area between each flange portion 5 and the ground plate 3a.

Since the irregular portion 7 is formed, the contact surface pressure between the ground plates 3a and 3b can be increased, and the reliability of electrical connection can be increased. As a result, the risk of contact failure between the ground plates 3a and 3b can be reduced and the intermodulation distortion can be suppressed.

The present invention is not limited to the above-described embodiment, and various modifications are, of course, possible within the scope of the present invention.

For example, in the above-described embodiment, the triplate lines 4a and 4b respectively include the central conductor plates 2a and 2b as the central conductors 2. However, the present invention is not limited to this, and one or both of the triplate lines 4a and 4b may be a substrate triplate line in which a wiring pattern formed on a dielectric substrate is used as the central conductor 2.

What is claimed is:

1. An antenna device comprising:
triplate lines used as feed lines, each triplate line including two ground plates and a central conductor interposed between the ground plates with an air layer provided between the central conductor and each ground plate,
wherein the triplate lines include
a first triplate line;
a second triplate line connected to the first triplate line across the first triplate line, the two ground plates of the second triplate line including respective flange portions configured to contact with a surface of one of the ground plates of the first triplate line; and
an irregular portion formed on at least one of a surface of each flange portion contacting the one of the ground plates of the first triplate line and the surface of the one of the ground plates of the first triplate line contacting each flange portion, the irregular portion configured to reduce a contact area between each flange portion and the one of the ground plates.

2. The antenna device according to claim 1,
wherein the irregular portion is formed only on the surface of the one of the ground plates of the first triplate line that contacts each flange portion.

3. The antenna device according to claim 1,
wherein each flange portion is fastened to the ground plates of the first triplate line with a bolt.

4. The antenna device according to claim 1,
wherein the irregular portion includes a protrusion formed by embossing.

5. The antenna device according to claim 1,
wherein the irregular portion includes a recess.
